(19) United States
(12) Patent Application Publication
(10) Pub. No.: US 2025/0173934 A1
(43) Pub. Date: May 29, 2025

(54) SYSTEM FOR ENHANCING ANIMATION MEDIA PRODUCTION AND METHOD THEREOF

(71) Applicant: Wei-Cheng KUO, San Jose, CA (US)

(72) Inventor: Wei-Cheng KUO, San Jose, CA (US)

(21) Appl. No.: 18/521,087

(22) Filed: Nov. 28, 2023

(51) Int. Cl. G06T 13/20; G06T 7/20; G06T 7/50; G06T 15/50; G06T 19/00

(52) U.S. Cl. CPC G06T 13/20; G06T 7/20; G06T 7/50; G06T 15/506; G06T 19/006; G06T 2200/24; G06T 2207/10016; G06T 2207/20084

(57) ABSTRACT

A system for enhancing animation media production that yields animated media or scenes that seamlessly blend with real-world environments. The system comprises a computing device having at least one processor and a memory in communication with the processor configured to store instructions that are executable by the processor. The computing device is in communication with a server through a network. The system uses neural radiance field (NeRF) system to provide depth maps. The system uses simultaneous localization and mapping system to monitor and map the environment in a 3D model of a scene in real-time environments. The system uses distributed AI agents, which ensures animated characters and elements can instantly adapt to dynamic changes in the environment, thereby eliminating post-production corrections when unexpected changes occur during filming. The system computes accurate lighting conditions and perspectives of the animated elements.

### FIELD OF THE INVENTION

The present disclosure relates generally to a system for improving the animation pipeline, and more particularly to a system for enhancing animation media production that yields animated media or scenes that seamlessly blend with real-world environments.

### BACKGROUND

Animation scene production is the process of creating a single scene in an animated film. Integrating animated characters or elements seamlessly within real-world footage can be a challenging task, but it is a skill that is becoming increasingly in demand as technology advances and the lines between live-action and animation continue to blur. This integration presents specific problems like depth discrepancies, spatial inaccuracies, real-time adaptability, perspective and light consistency, and complex interactions. There are a number of different techniques that can be used to integrate animated characters or elements into real-world footage, for example, rotoscoping, keying, and 3D tracking.

NeRF (Neural Radiance Fields) and SLAM (Simultaneous Localization and Mapping) are two rapidly developing technologies that have the potential to revolutionize many different fields. The NeRF is a technique for modeling 3D scenes from images. It works by training a neural network to predict the color and brightness of each ray of light that passes through a scene. This allows the NeRF to generate realistic 3D models of objects and environments from just a few images. The SLAM is a system for estimating the position and orientation of a robot or other device in real time. It works by tracking the movement of the device and its relationship to the surrounding environment. The SLAM is used in a variety of applications, including robotics, navigation, and self-driving cars.

The NeRF is a deep learning-based method, which is used for creating and rendering 3D scenes. It works by learning a continuous representation of the scene's radiance and density from input images, which is then utilized to render new views of the scene from any vantage point. A radiance field for an object represents and visualizes the object in a three-dimensional rendering space, allowing various renderings such as images or videos to be generated. However, the NeRF framework for generating different views of an object can be computationally intensive, particularly after a machine learning model has been trained to encode a radiance field of an object onto the model. This computational complexity can prohibit the real-time rendering of objects through radiance fields, making the process difficult and in some cases, nearly impractical.

The SLAM is used to track the movement of actors and objects in a scene, which can then be used to animate 3D characters and objects. The SLAM can also be used to create virtual sets, which can be used to save time and money on location shoots. Despite the advantages that improve the animation production process, the SLAM faces some challenges in accuracy, real-time performance, robustness, scalability, etc. By fusing the NeRF with the SLAM in animation production, high-quality film content can be achieved which is indistinguishable from the real world.

Therefore, there is a need for a system for enhancing animation media production that yields animated media or scenes that seamlessly blend with real-world environments. Additionally, there is also a need for a system that can generate a refined depth map with far greater detail than traditional methods, thereby enhancing depth accuracy. There is also a need for a system that uses distributed AI agents, which ensures that animated characters and elements can instantly adapt to dynamic changes in the environment, thereby eliminating post-production corrections when unexpected changes occur during filming. There is also a need for a system that computes accurate lighting conditions and perspectives of the animated elements. There is also a need for a system that uses distributed AI agents to recognize and address intricate interactions between animated and real-world elements. Further, there is also a need for a system that improves scalability of the animated media or scenes.

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a system for enhancing animation media production that yields animated media or scenes that seamlessly blend with real-world environments.

In one embodiment herein, the system for enhancing animation media production comprises a computing device having at least one processor and a memory in communication with the processor and configured to store instructions that are executable by the processor. The computing device is in communication with a server through a network. The processor is configured to execute the stored instructions to cause the system to perform operations.

In one embodiment herein, the processor is configured to analyze media data to identify a plurality of static and dynamic elements in the media data. In particular, the media data includes at least one of video files, image files, and audio files. In specific, the static and dynamic elements includes animation characters, animation elements, objects, and props.

In one embodiment herein, the processor is configured to render a three-dimensional (3D) model of a scene with a precise depth and location data based on radiance information and spatial data of the plurality of static and dynamic elements in the media data through a neural network to ensure placement of the plurality of static and dynamic elements in the 3D model of the scene. In specific, the neural network is a neural radiance field (NeRF). In one embodiment herein, the processor is configured to provide depth maps through the NeRF, thereby ensuring interaction of the plurality of static and dynamic elements with props and an environment in the 3D model of the scene.

In one embodiment herein, the processor is configured to monitor and map the environment in the 3D model of the scene through a simultaneous localization and mapping system in real-time, thereby ensuring accurate interactions between the plurality of dynamic elements and the 3D model of the scene. In particular, the simultaneous localization and mapping system is configured to update and refine the depth maps for correcting inaccuracies.

The simultaneous localization and mapping system is configured to perform global optimization to ensure that the media data is consistent and accurate. The simultaneous localization and mapping system is configured to segregate the dynamic elements and stable a structure of the 3D model of the scene. The simultaneous localization and mapping system is configured to identify and extract key visual features within the 3D model of the scene, thereby generating a plurality of reference points for tracking the plurality of dynamic elements. The simultaneous localization and mapping system is configured to match the current key visual features with previous frames to determine motion and trajectory in the 3D model of the scene.

In one embodiment herein, the processor is configured to track the plurality of dynamic elements within a dynamic scene of the 3D model of the scene through the simultaneous localization and map system to maintain consistent and accurate relative positions of the plurality of dynamic elements. In one embodiment herein, the processor is configured to identify and adjust optimal positions of the plurality of dynamic and static elements in the 3D model of the scene through one or more distributed artificial intelligence (AI) agents to ensure that the plurality of static and dynamic elements are precisely placed in the 3D model of the scene with respect to depth and interaction.

In one embodiment herein, the distributed AI agents are configured to analyze the 3D model of the scene to identify environmental features, lighting conditions, potential interaction points, and possible animation placement zones. The distributed artificial intelligence (AI) agents are configured to collaborate in real-time, share information, and plan optimal animation placements, thereby fetching appropriate static and dynamic elements from a database based on defined positions and the potential interaction points.

The distributed AI agents are configured to adapt and context one or more animation parameters from the 3D model of the scene according to real-world scenes context. In specific, the one or more animation parameters includes pose, orientation and lighting of the 3D model of the scene. The distributed AI agents are configured to place the adapted one or more animation parameters into the 3D model of the scene at one or more predetermined zones, thereby ensuring natural interactions.

The distributed AI agents are configured to adjust the one or more animation parameters continuously for maintaining the 3D model of the scene with consistent and interactive animations. The distributed AI agents are configured to gather the feedback on the placements, the interactions, and the adaptions to adjust the 3D model of the scene, thereby enhancing realism. The distributed AI agents are recognize and address intricate interactions between the static elements, the dynamic elements and real-world elements.

In one embodiment herein, the system analyses the 3D model of the scene and continuously gather feedback on placements, interactions, and adaptations and make adjustments accordingly for enhancing animation media production in real-time. In one embodiment herein, the system is configured to receive the media data from the simultaneous localization and map system and the NeRF, respectively, thereby adjusting lighting and perspective for the plurality of static and dynamic elements of the 3D model of the scene to ensure that plurality of static and dynamic elements match real-world conditions.

An embodiment of the first aspect, the invention provides a method for enhancing animation media production using the system. The user is enabled to access the enhancing animation media production using the system by providing user credentials through the user interface of the computing device. In specific, the computing device having the processor and the memory in communication with the processor configured to store instructions that are executable by the processor.

At one step, the processor renders the three-dimensional (3D) model of the scene with the precise depth and location data based on radiance information and spatial data of the plurality of static and dynamic elements in the media data through the NeRF to ensure placement of the plurality of static and dynamic elements in the 3D model of the scene. At one step, the processor provides depth maps through the NeRF, thereby ensuring interaction of the plurality of static and dynamic elements with props and an environment in the 3D model of the scene.

At one step, the processor monitors and maps the environment in the 3D model of the scene through the simultaneous localization and mapping system in real-time, thereby ensuring accurate interactions between the plurality of dynamic elements and the 3D model of the scene. At one step, the processor tracks the plurality of dynamic elements within the dynamic scene of the 3D model of the scene through the simultaneous localization and mapping system to maintain consistent and accurate relative positions of the plurality of dynamic elements.

At one step, the processor identifies and adjusts optimal positions of the plurality of dynamic and static elements in the 3D model of the scene through one or more distributed AI agents to ensure that the plurality of static and dynamic elements are precisely placed in the 3D model of the scene with respect to depth and interaction. At one step, the processor adjusts lighting and perspective of the plurality of static and dynamic elements in the 3D model of the scene to ensure that the plurality of static and dynamic elements match real-world conditions.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a block diagram of a system for enhancing animation media production, in accordance with embodiments of the invention.

FIG. 2 illustrates an overall flowchart of a work flow of the system for enhancing the animation media production, in accordance with embodiments of the invention.

FIG. 3 illustrates a flowchart representing an integration of a simultaneous localization and mapping (SLAM) system, in accordance with embodiments of the invention.

FIG. 4 illustrates a flowchart for animation placement with distributed artificial intelligence (AI) agents, in accordance with another embodiment of the invention.

FIG. 5 illustrates a flowchart of a method for enhancing animation media production using the system, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

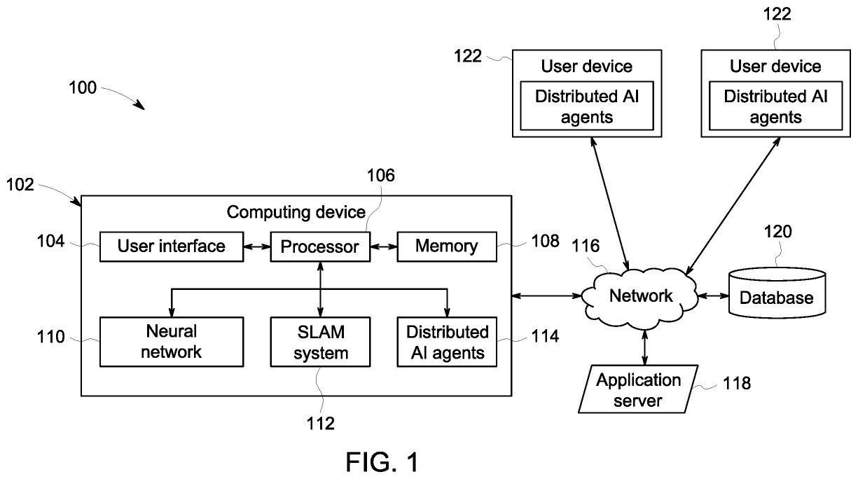

FIG. 1 refers to a block diagram of a system 100 for enhancing animation media production. The system 100 yields animated media or scenes that seamlessly blend with real-world environments. The system 100 generates a refined depth map with far greater detail than traditional methods, thereby enhancing depth accuracy of animated media or scenes. The system 100 computes accurate lighting conditions and perspectives of the static and dynamic elements. The system 100 improves scalability of the animated media or scenes.

In one embodiment herein, the system 100 comprises a computing device 102 having at least one processor 106. The computing device 102 is in communication with an application server 118 through a network 116. The computing device 102 further comprises a memory 108 in communication with the processor 106. The memory 108 is configured to store instructions that are executable by the processor 106. In one embodiment herein, the computing device 102 is configured to enable a user to access for creating and enhancing the animation media production by providing user credentials through a user interface 104 of the computing device 102.

In another embodiment, the term “computing device 102” is used generally herein to refer to any computing device configured to perform operations of the various embodiments, including one or all of personal computers, cellular telephones, smart phones, personal data assistants (PDA's) laptop computers, tablet computers, smart books, palm-top computers, wireless electronic mail receivers, multimedia Internet enabled cellular telephones, and similar personal electronic devices.

In another embodiment herein, the network 116 could be, but is not limited to, Wi-Fi, Bluetooth, a wireless local area network (WLAN)/Internet connection, and radio communication. In some embodiments, the computing device 102 could be touchscreen and/or non-touchscreen and adopted to run on any type of OS, such as iOS, Windows, Android, Unix, Linux and/or others.

In one example embodiment herein, the application server 118 could be a server work as an intermediary between a database 120, which store application data and the user data. In an embodiment herein, the application server 118 is at least one of a general or special purpose computer or a server. The application server 118 could be operated as a single computer, which can be a hardware and/or software server, a workstation, a desktop, a laptop, a tablet, a mobile phone, a mainframe, a supercomputer, a server farm, and so forth.

In one embodiment herein, the processor 106 is a central processing unit that is configured to execute the stored instructions to cause the system 100 to perform one or more operations to provide seamless integration of animated objects into real-world footage, and thereby enhancing an animation media production. The processor 106 is configured to analyze a media data to identify a plurality of static and dynamic elements in the media data. In specific, the media data includes at least one of video files, image files, and audio files. Further, the static and dynamic elements includes animation characters, animation elements, objects, and props.

The processor 106 is configured to render a three-dimensional (3D) model of a scene with a precise depth and location data based on radiance information and spatial data of the static and dynamic elements in the media data through a neural network 110 to ensure placement of the static and dynamic elements in the 3D model of the scene.

In one embodiment, the neural network 110 could be a neural radiance field (NeRF), which is a framework used to render elements by leveraging radiance fields of those elements. A radiance field, also known as a light field, is a comprehensive representation of the light that is reflected by an element in a 3D space. This representation can be used to generate various renderings, such as images or videos, of the object from different viewpoints, which can be used to create unique and visually appealing animations.

In another embodiment, the NeRF is a deep learning system that allows the creation of high-fidelity 3D models from 2D images. By using the NeRF, a user (an animator) can create highly realistic virtual environments that can be used as backdrops for their animations.

In one embodiment, radiance fields are typically created by capturing the light intensity and direction at many points in a 3D space. This information is then used to generate a comprehensive representation of the element's appearance and lighting. The resulting radiance field can be thought of as a 4D dataset that contains all the information necessary to render the element from any viewpoint. By leveraging the radiance fields, it is possible to create a wide range of visualizations and animations that would be difficult or impossible to achieve using traditional rendering techniques.

In another embodiment, the processor 106 renders the 3D model of the scene with the assistance of the NeRF, which ensures that each static and dynamic element in the 3D model of the scene is placed accurately. This is done by analyzing and processing the data received from the radiance information and spatial data of the static and dynamic elements, which assistances generate a detailed 3D model of the scene. With the assistance of this technology, the processor 106 can create accurate 3D models of any scene, whether it be the real world or a virtual environment. This technology is highly beneficial in various fields such as gaming, virtual reality, and simulation, where having a precise 3D model of the scene is crucial.

The processor 106 is configured to provide one or more depth maps through the NeRF, thereby ensuring interaction of the static and dynamic elements with props and an environment in the 3D model of the scene.

In another embodiment, the processor 106 creates a realistic 3D model of the scene. The processor 106 is trained to generate the depth maps by using the neural network 110 i.e., neural radiance field (NeRF). These depth maps enable the static and dynamic elements to interact seamlessly with the environment and props in the processor 106. The NeRF ensures that the 3D model accurately replicates real-life scenes and, thereby creating a more immersive experience for viewer.

The processor 106 is configured for monitoring and mapping the environment in the 3D model of the scene through a simultaneous localization and mapping system 112 (SLAM system) in real-time, thereby ensuring accurate interactions between the dynamic elements and the 3D model of the scene.

In one embodiment, the processor 106 is programmed to perform a range of tasks in relation to the 3D model of the scene. Its key functionality includes monitoring and mapping the environment in real-time, through the use of the SLAM system 112. This advanced technology enables the processor 106 to accurately track the movements of dynamic elements within the environment, such as people, objects, props and vehicles. By doing so, the SLAM system 112 ensures that the 3D model of the scene remains up-to-date and reflects the current state of the environment accurately. Further, the SLAM system 112 is configured to update and refine the depth maps for correcting inaccuracies. The SLAM system 112 is configured to perform global optimization to ensure that the media data is consistent and accurate. The SLAM system 112 is configured to segregate the dynamic elements and stable a structure of the 3D model of the scene.

The SLAM system 112 is configured to identify and extract key visual features within the 3D model of the scene, thereby generating a plurality of reference points for tracking the plurality of dynamic elements. The SLAM system 112 is configured to match the current key visual features with previous frames to determine motion and trajectory in the 3D model of the scene.

In another embodiment, the SLAM system 112 is configured to provide precise and reliable data on the movements of dynamic elements, which are crucial for facilitating seamless interactions between these elements and the 3D model of the scene. This, in turn, enhances the user's experience by creating a more immersive and realistic animations. The real-time monitoring and mapping capabilities of the SLAM system 112, ensures accurate interactions between the dynamic elements and the 3D model of the scene.

The processor 106 is configured to track the dynamic elements within a dynamic scene of the 3D model of the scene through the SLAM system 112 to maintain consistent and accurate relative positions of the dynamic elements. The SLAM system 112 allows the processor 106 to maintain consistent and precise relative positions of the dynamic elements, ensuring that the virtual representation of the scene accurately reflects the real-world environment.

In one embodiment, the SLAM system 112 is a computational technique used to map the dynamic elements within the dynamic scene of the 3D model of the scene. The key objective of the SLAM system 112 is to enable the system 100 to navigate through the 3D model of the scene, while at the same time creating a map of the dynamic scene and keeping track of its own position in real-time. In general, the SLAM system 112 detects and localizes the elements in the dynamic scene. The detected data is then processed to estimate the dynamic elements, position and map the environment. In another embodiment, the SLAM system 112 enables real-time mapping and tracking of the environment. This allows for the creation of more accurate and immersive experience to the viewer or user.

The processor 106 is configured to identify and adjust one or more optimal positions of the dynamic and static elements in the 3D model of the scene through one or more distributed artificial intelligence (AI) agents 114 to ensure that the static and dynamic elements are precisely placed in the 3D model of the scene with respect to depth and interaction.

The processor 106 is configured to analyze the depth map from the SLAM system 112, the NeRF and the media data or scene frames to adjust lighting and perspective for the static and dynamic elements of the 3D model of the scene. This ensures that the static and dynamic elements match real-world conditions.

In one embodiment, the distributed AI agents 114 are configured to analyze the 3D model of the scene to identify environmental features, lighting conditions, potential interaction points, and possible animation placement zones. The distributed AI agents 114 further collaborate in real-time, share information, and plan optimal animation placements, thereby fetching appropriate static and dynamic elements from a database 120 based on defined positions and the potential interaction points. In one embodiment, the distributed AI agents 114 may be trained using at least one machine learning algorithm and at least one neural network for enhancing animation media production.

In one embodiment, the distributed AI agents 114 adapt and context one or more animation parameters from the 3D model of the scene according to real-world scenes context. The distributed AI agents 114 place the adapted one or more animation parameters into the 3D model of the scene at one or more predetermined zones, thereby ensuring natural interactions. Further, the animation parameters includes pose, orientation and lighting of the 3D model of the scene.

In one embodiment, the distributed AI agents 114 adjust the one or more animation parameters continuously for maintaining the 3D model of the scene with consistent and interactive animations. Further, the distributed AI agents 114 gather the feedback on the placements, the interactions, and the adaptions to adjust the 3D model of the scene, thereby enhancing realism. Furthermore, the distributed AI agents 114 recognize and address intricate interactions between the static elements, the dynamic elements and real-world elements.

In another embodiment, the distributed AI agents 114 are configured to select at least one static and dynamic element from the database 120 based on the optimal position. The optimal position comprises one or more defined positions and interaction points with the 3D model of the scene. The distributed AI agents 114 are configured to select the animated static and dynamic elements from the database 120 based on the optimal position.

In another embodiment, the distributed AI agents 114 are intelligent computer programs that can be distributed across multiple devices. By using the distributed AI agents 114, the user can automate various tasks such as character animation, crowd simulation, and physics simulations, which significantly reduces the time spent on manual adjustments and corrections.

In some embodiments, the distributed AI agents 114 use artificial intelligence to simulate conversation with human users. The distributed AI agents 114 are typically powered by natural language processing (NLP) and machine learning (ML), which allow them to understand and respond to human language in a natural and engaging way.

In some embodiments, the database 120 resides in the connected application server 118 or a cloud computing service. Regardless of a location, the database 120 comprises a memory to store and organize the media data.

In another embodiment herein, the distributed AI agents 114 are configured to communicate with one or more distributed AI agents of other user devices 122 through the processor 106 via the network 116. The distributed AI agents 114 could interact with the distributed AI agents 114 of the other user devices 122 for executing the multiple tasks in real-time to provide the final 3D model of the scene. This enables the distributed AI agents 114 seamlessly and remotely collaborate with the distributed AI agents 114 of the other user devices 122 through the network 116 as depicted in FIG. 1. This architecture offers several advantages include enhanced collaboration between the distributed AI agents 114 and accommodate a growing number of distributed AI agents 114 and the user devices 122 without compromising its functionality. In one embodiment herein, the distributed AI agents 114 of the computing device 102 perform final rendering of the 3D model of the scene. In one embodiment herein, the distributed AI agents of the other user devices or computing devices 122 could be used to track the character movements, simultaneous localization and mapping (SLAM), audio script lip sync, etc.

In one embodiment herein, the user devices 122 includes at least one of a smartphone, a tablet, a computer, a laptop, and thereof. In some embodiments, the user devices 122 could be touchscreen and/or non-touchscreen and adopted to run on any type of OS, such as iOS, Windows, Android, Unix, Linux and/or others.

In some embodiments, the processor 106 is configured to enable the distributed AI agents 114 to interact with each other and the user for clarifications and additional information. These distributed AI agents 114 possess specific skills, expertise, and experience, which they utilize optimally to perform task.

In one embodiment, the integration of the NeRF, the SLAM system 112 and the distributed AI agents 114 has revolutionized the animation process, offering unparalleled levels of automation and accuracy. With these advanced tools, the user can now spend less time on manual adjustments and corrections, and instead focus on more creative aspects of the animation. By integrating these technologies, the user can create highly realistic and immersive animations in a shorter amount of time, with a higher degree of accuracy from the outset. This results in a more streamlined production timeline, fewer revisions, and ultimately, a better end product.

In another embodiment, the system 100 is a highly adaptable tool that can be effectively utilized across various film genres, ranging from fantasy and sci-fi to documentaries. This versatility enables filmmakers to explore creative possibilities that were previously considered too challenging or unrealistic. With the system 100, directors and creators can now visualize even the most complex scenes in great detail, paving the way for innovative and captivating storytelling. The system 100 expands the potential market reach for filmmakers, providing them with an opportunity to showcase their creativity and imagination without the limitations of conventional technology.

In another embodiment, the integration of the system 100 provides a unique opportunity for production houses to establish themselves as leaders in technological advancement within the film industry. The utilization of the system 100 not only attracts highly skilled professionals but also appeals to potential investors. Additionally, the system 100 is ideal for merging real-world and animated media or scenes with virtual objects for immersive virtual reality (VR) and augmented reality (AR) applications. Interactions with the virtual environment produce accurate final products. In light of this, the implementation of the NeRF, the SLAM system 112, and the distributed AI agents 114 into production houses is a prudent and strategic move that can significantly increase their competitiveness and marketability.

In some embodiments, the system 100 is designed to provide a platform for users to communicate with the distributed AI agents 114. This system 100 enables users to collaborate with these distributed AI agents 114 to create animated media or movies that are intended for storytelling, visualizing narratives, and understanding and comparing the perceptions of both human and AI agents.

In some embodiments, a narrative is a sequence of events that is intended to inform, educate, or entertain. In some examples, the system 100 allows users to create illustrated books for children that are similar in format to the narrative. The system 100 provides a unique opportunity for users to interact with the distributed AI agents 114 in a collaborative manner to explore different perspectives and create engaging content. The distributed AI agents 114 have the ability to provide valuable insights and suggestions, which can be used to improve the overall quality of the final product. The resulting animated media or movies can be used for a range of purposes, including education, entertainment, and marketing.

In some embodiments herein, the system 100 could be a mixed-initiative system. In some embodiments, collaborative interactive storytelling can be a complex task. To achieve the task, the system 100 can be used, where one or more users work together with one or more distributed AI agents 114, creating a team where each member can contribute their respective skills to the task at hand. One of the primary objectives in the system 100 is to generate an animation media or video based on the user inputs and user interactions. By identifying and communicating about the various sub-tasks involved in interactive storytelling, the team can significantly improve their ability to complete tasks and achieve their goal through the distributed AI agents 114. This not only enhances the quality of the final product but also improves the overall experience for the end-user.

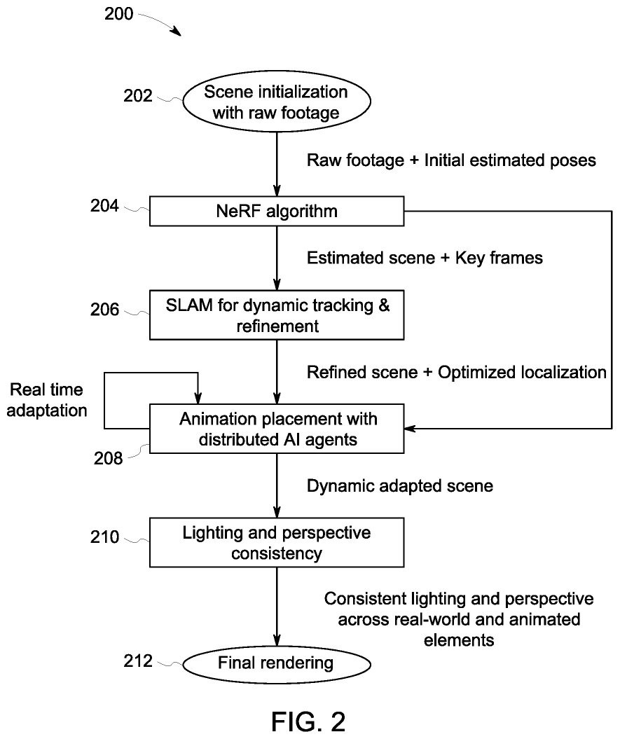

FIG. 2 refers to an overall flowchart 200 of a work flow of the system 100 for enhancing the animation media production. In one embodiment herein, the at least one memory 108 is communicatively coupled to the at least one processor 106 to store at least one of processor 106—executable instructions or data.

At step 202, the processor 106 analyzes the media data to identify the plurality of static and dynamic elements in the media data. At step 204, the processor 106 renders the three-dimensional (3D) model of the scene with the precise depth and location data based on radiance information and spatial data of the plurality of static and dynamic elements in the media data through the NeRF to ensure placement of the plurality of static and dynamic elements in the 3D model of the scene. The NeRF could provide depth maps, thereby ensuring interaction of the plurality of static and dynamic elements with props and an environment in the 3D model of the scene.

At step 206, the processor 106 monitors and maps the environment in the 3D model of the scene through the simultaneous localization and mapping system 112 in real-time, thereby ensuring accurate interactions between the plurality of dynamic elements and the 3D model of the scene. At step 208, the processor 106 tracks the plurality of dynamic elements within the dynamic scene of the 3D model of the scene through the simultaneous localization and mapping system 112 to maintain consistent and accurate relative positions of the plurality of dynamic elements.

At step 210, the processor 106 identifies and adjusts optimal positions of the plurality of dynamic and static elements in the 3D model of the scene through one or more distributed AI agents 114 to ensure that the plurality of static and dynamic elements are precisely placed in the 3D model of the scene with respect to depth and interaction. At step 212, the processor 106 adjusts lighting and perspective of the plurality of static and dynamic elements in the 3D model of the scene to ensure that the plurality of static and dynamic elements match real-world conditions. The entire scene with consistent lighting and perspective undergoes a final rendering process, refining any last minute visual details and ensuring optimal visual quality. The 3D model of the final rendered scene is ready for inclusion in a film.

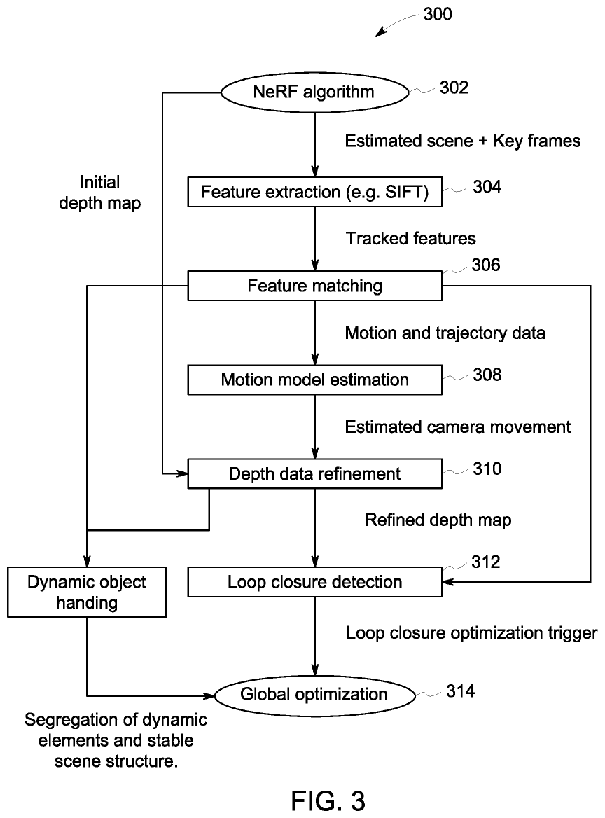

FIG. 3 refers to a flowchart 300 representing an integration of Simultaneous Localization and Mapping (SLAM) system 112. The SLAM system 112 is commonly used in robotics, which can map an environment and track an entity's movement in real-time. The SLAM system 112 actively tracks the plurality of dynamic elements within a dynamic scene, such as characters or moving objects, ensuring they maintain consistent and accurate relative positions. This aids in creating a more believable intricate animated media or scene. Additionally, as characters or objects move through scenes, the SLAM system 112 updates the environment map in real-time, adapting to any dynamic changes and ensuring accurate interactions.

In some embodiments, at step 302, the SLAM system 112 uses initial pose in the media data as a reference and establishes key frames based on the initial pose, thereby obtaining defined key frames and reference points for tracking. At step 304, the system 100 identifies and extracts key visual features (like corners, texture changes) within the media data or scene. These features serve as reference points for movement tracking of the plurality of dynamic elements. At step 306, the system 100 matches current features with those from previous frames to determine motion and changes, thereby obtaining motion vectors and trajectory data. At step 308, the system 100 estimates the camera movement and trajectory in the media data or scene. At step 310, the SLAM system 112 updates and refines the depth maps, correcting inaccuracies and adding more detail where required to obtain a refined and accurate depth maps. At step 312, the system 100 continuously checks if the camera has returned to a previously visited location (a “loop”). If detected, any accumulated drift in tracking is corrected. The SLAM system 112 segregates the dynamic elements within the scene and stable scene structure. At step 313, the SLAM system 112 tracks the dynamic objects detected in the scene separately based on the motion vectors and trajectory data to ensure that the dynamic objects do not interfere the scene stability, thereby achieving effective dynamic object handling. At step 314, the SLAM system 112 performs a global optimization to ensure all data is consistent and accurate. The SLAM system 112 generates optimized camera trajectory, pose, and depth map.

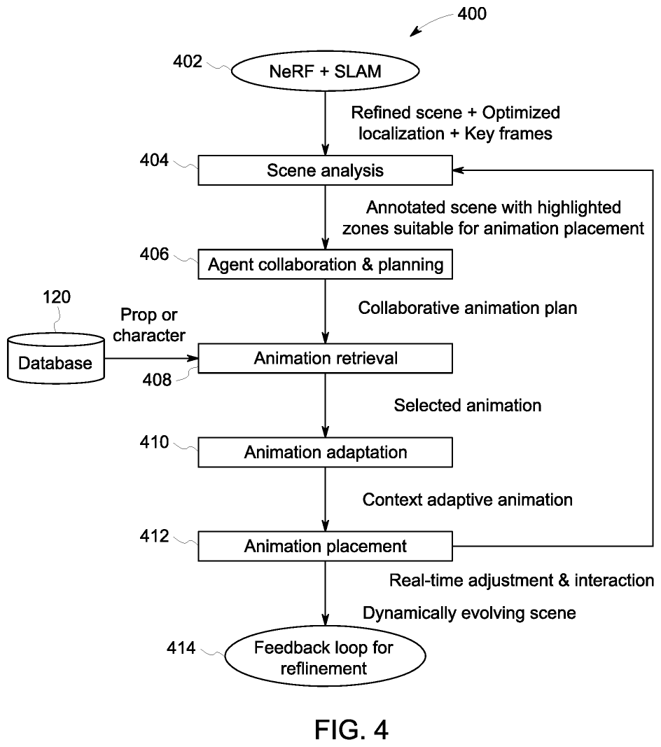

FIG. 4 refers a flowchart 400 for animation placement with the distributed AI agents. In one embodiment herein, the distributed AI agents 114 continually monitor the media data or scenes. When changes occur, the distributed AI agents 114 instantly adjust the static and dynamic elements in the 3D model of the scene. At step 402, the depth map from the SLAM system 112 and the 3D model of the scene is taken as an input. At step 404, the distributed AI agents 114 analyze the 3D model of the scene to identify environmental features, lighting conditions, potential interaction points, and possible animation placement zones. At step 406, the distributed AI agents 114 generates collaborative placement plan with positions, orientations, and interaction points for animations. At step 408, based on the defined positions and interaction points, the distributed AI agents 114 fetch appropriate animations or characters from the database 120. At step 410, the distributed AI agents 114 adapt the animation parameters like pose, orientation, and lighting according to the real-world scene's context.

At step 412, the distributed AI agents 114 place the adapted animations into the media data or scene at the predetermined zones. As the real-world scene evolves (e.g., lighting changes, objects move), the distributed AI agents 114 continuously adjust the one or more animation parameters for consistency. Moreover, if any interactive elements are present, the distributed AI agents 114 manage real-time interactions between animations and real-world elements. At step 414, the distributed AI agents 114 continuously gather feedback on the placements, the interactions, and the adaptions. If an animation seems out of place or if a real-world object interferes with the animation, adjustments are made accordingly.

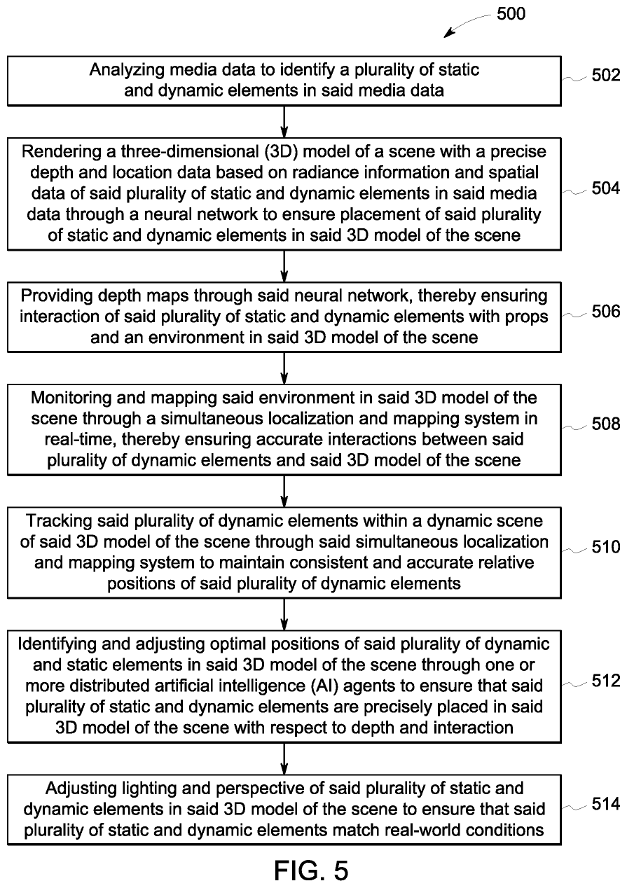

FIG. 5 refers to a flowchart 500 of a method for enhancing animation media production using a system 100. The user is enabled to access the enhancing animation media production using the system 100 by providing user credentials through the user interface 104 of the computing device 102. In specific, the computing device 102 having the processor 106 and the memory 108 in communication with the processor 106 configured to store instructions that are executable by the processor 106.

At step 502, the processor 106 analyzes media data to identify the plurality of static and dynamic elements in the media data. At step 504, the processor 106 renders the three-dimensional (3D) model of the scene with the precise depth and location data based on radiance information and spatial data of the plurality of static and dynamic elements in the media data through the NeRF to ensure placement of the plurality of static and dynamic elements in the 3D model of the scene. At step 506, the processor 106 provides depth maps through the NeRF, thereby ensuring interaction of the plurality of static and dynamic elements with props and an environment in the 3D model of the scene.

At step 508, the processor 106 monitors and maps the environment in the 3D model of the scene through the SLAM system112 in real-time, thereby ensuring accurate interactions between the plurality of dynamic elements and the 3D model of the scene. At step 510, the processor 106 tracks the plurality of dynamic elements within the dynamic scene of the 3D model of the scene through the SLAM system 112 to maintain consistent and accurate relative positions of the plurality of dynamic elements.

At step 512, the processor 106 identifies and adjusts optimal positions of the plurality of dynamic and static elements in the 3D model of the scene through the distributed AI agents 114 to ensure that the plurality of static and dynamic elements are precisely placed in the 3D model of the scene with respect to depth and interaction. At step 514, the processor 106 adjusts the lighting and perspective of the plurality of static and dynamic elements in the 3D model of the scene to ensure that the plurality of static and dynamic elements match real-world conditions.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A system for enhancing animation media production, comprising:
a computing device having at least one processor, wherein the computing device is in communication with a server through a network; and
a memory in communication with said processor configured to store instructions that are executable by said processor,
wherein said processor is configured to execute the stored instructions to cause the system to perform operations comprising:
analyzing media data to identify a plurality of static and dynamic elements in said media data;
rendering a three-dimensional (3D) model of a scene with a precise depth and location data based on radiance information and spatial data of said plurality of static and dynamic elements in said media data through a neural network to ensure placement of said plurality of static and dynamic elements in said 3D model of the scene;
providing depth maps through said neural network, thereby ensuring interaction of said plurality of static and dynamic elements with props and an environment in said 3D model of the scene;
monitoring and mapping said environment in said 3D model of the scene through a simultaneous localization and mapping system in real-time, thereby ensuring accurate interactions between said plurality of dynamic elements and said 3D model of the scene;
tracking said plurality of dynamic elements within a dynamic scene of said 3D model of the scene through said simultaneous localization and mapping system to maintain consistent and accurate relative positions of said plurality of dynamic elements; and
identifying and adjusting optimal positions of said plurality of dynamic and static elements in said 3D model of the scene through one or more distributed artificial intelligence (AI) agents to ensure that said plurality of static and dynamic elements are precisely placed in said 3D model of the scene with respect to depth and interaction,
whereby said system analyses said 3D model of the scene and continuously gather feedback on placements, interactions, and adaptations and make adjustments accordingly for enhancing animation media production in real-time.

2. The system of claim 1, wherein the system is configured to
adjust lighting and perspective for said plurality of static and dynamic elements of said 3D model of the scene to ensure that plurality of static and dynamic elements match real-world conditions.

3. The system of claim 1, wherein the neural network is a neural radiance field (NeRF) system.

4. The system of claim 1, wherein the distributed AI agents are configured to:
analyze said 3D model of the scene to identify environmental features, lighting conditions, potential interaction points, and possible animation placement zones;
collaborate in real-time, share information, and plan optimal animation placements, thereby fetching appropriate static and dynamic elements from a database based on defined positions and the potential interaction points;
adapt and context one or more animation parameters from said 3D model of the scene according to real-world scenes context;
place the adapted one or more animation parameters into said 3D model of the scene at one or more predetermined zones, thereby ensuring natural interactions;
adjust the one or more animation parameters continuously for maintaining said 3D model of the scene with consistent and interactive animations; and
gather the feedback on the placements, the interactions, and the adaptions to adjust said 3D model of the scene, thereby enhancing realism.

5. The system of claim 1, wherein the media data includes at least one of video files, image files, and audio files.

6. The system of claim 1, wherein the static and dynamic elements includes animation characters, animation elements, objects, and props.

7. The system of claim 1, wherein the simultaneous localization and mapping system is configured to update and refine the depth maps for correcting inaccuracies.

8. The system of claim 1, wherein the simultaneous localization and mapping system is configured to perform global optimization to ensure that the media data is consistent and accurate.

9. The system of claim 1, wherein the simultaneous localization and mapping system is configured to segregate the dynamic elements and stable a structure of said 3D model of the scene.

10. The system of claim 1, wherein the simultaneous localization and mapping system is configured to identify and extract key visual features within said 3D model of the scene, thereby generating a plurality of reference points for tracking said plurality of dynamic elements.

11. The system of claim 1, wherein the simultaneous localization and mapping system is configured to match the current key visual features with previous frames to determine motion and trajectory in said 3D model of the scene.

12. The system of claim 1, wherein the distributed AI agents is configured to recognize and address intricate interactions between the static elements, the dynamic elements and real-world elements.

13. The system of claim 1, wherein the one or more animation parameters includes pose, orientation and lighting of said 3D model of the scene.

14. A method for enhancing animation media production using a system, comprising:
enabling a user to access said system by providing user credentials through a user interface of a computing device,
wherein said computing device having at least one processor and a memory in communication with said processor configured to store instructions that are executable by said processor;
analyzing media data to identify a plurality of static and dynamic elements in said media data;
rendering a three-dimensional (3D) model of a scene with a precise depth and location data based on radiance information and spatial data of said plurality of static and dynamic elements in said media data through a neural network to ensure placement of said plurality of static and dynamic elements in said 3D model of the scene;
providing depth maps through said neural network, thereby ensuring interaction of said plurality of static and dynamic elements with props and an environment in said 3D model of the scene;
monitoring and map said environment in said 3D model of the scene through a simultaneous localization and mapping system in real-time, thereby ensuring accurate interactions between said plurality of dynamic elements and said 3D model of the scene;
tracking said plurality of dynamic elements within a dynamic scene of said 3D model of the scene through said simultaneous localization and mapping system to maintain consistent and accurate relative positions of said plurality of dynamic elements; and
identifying and adjusting optimal positions of said plurality of dynamic and static elements in said 3D model of the scene through one or more distributed artificial intelligence (AI) agents to ensure that said plurality of static and dynamic elements are precisely placed in said 3D model of the scene with respect to depth and interaction.

15. The method of claim 14, wherein the method comprises:
adjusting lighting and perspective of said plurality of static and dynamic elements in said 3D model of the scene to ensure that said plurality of static and dynamic elements match real-world conditions.

16. The method of claim 14, wherein the neural network is a neural radiance field (NeRF) system.

17. The method of claim 14, wherein the distributed AI agents are configured to analyze said 3D model of the scene to identify environmental features, lighting conditions, potential interaction points, and possible animation placement zones.

18. The method of claim 14, wherein the distributed AI agents are configured to fetch appropriate static and dynamic elements from a database based on the defined positions and interaction points.

19. The method of claim 14, wherein the media data includes at least one of video files, image files, and audio files.

20. A non-transitory computer readable medium having stored thereon computer-executable instructions which, when executed by an onboard computer of a system, cause the onboard computer to:
analyze media data to identify a plurality of static and dynamic elements in said media data;
render a three-dimensional (3D) model of a scene with a precise depth and location data based on radiance information and spatial data of said plurality of static and dynamic elements in said media data through a neural network to ensure placement of said plurality of static and dynamic elements in said 3D model of the scene;
provide depth maps through said neural network, thereby ensuring interaction of said plurality of static and dynamic elements with props and an environment in said 3D model of the scene;
monitor and map said environment in said 3D model of the scene through a simultaneous localization and mapping system in real-time, thereby ensuring accurate interactions between said plurality of dynamic elements and said 3D model of the scene;
track said plurality of dynamic elements within a dynamic scene of said 3D model of the scene through said simultaneous localization and mapping system to maintain consistent and accurate relative positions of said plurality of dynamic elements;
identify and adjusting optimal positions of said plurality of dynamic and static elements in said 3D model of the scene through one or more distributed artificial intelligence (AI) agents to ensure that said plurality of static and dynamic elements are precisely placed in said 3D model of the scene with respect to depth and interaction; and
adjust lighting and perspective of said plurality of static and dynamic elements in said 3D model of the scene to ensure that said plurality of static and dynamic elements match real-world conditions.
